(19) United States
(12) Patent Application Publication
(10) Pub. No.: US 2005/0018070 A1
(43) Pub. Date: Jan. 27, 2005

(54) Image obtaining apparatus with selectable filters

(76) Inventors: Ren Tsung Chang, Tu-Chen (TW); Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/899,565

(22) Filed: Jul. 26, 2004

(30) Foreign Application Priority Data
Jul. 25, 2003 (TW) 92213597

(51) Int. Cl. H04N 5/225

(52) U.S. Cl. 348/340

(57) ABSTRACT

An image obtaining apparatus comprises a securing frame securing frame (22) with a hollow center, a lens portion (21) secured in a top of the securing frame, a rotating means (23) comprising a turnplate (232) and a plurality of filters (23) embedded in the turnplate, and an image pick-up unit (24). The turnplate can be rotated to locate a selected one of the filters between the lens portion and the image pick-up unit.

### BACKGROUND OF THE INVENTION

1. Field of the Invention

The present invention generally relates to image obtaining apparatuses such as those used in digital cameras, and more particularly to an image obtaining apparatus using filters.

2. Prior Art

With the development of multi-media technology, digital cameras and video cameras are being embraced by more and more consumers. There is increasing demand for higher quality, more abundant and more variable kinds of object imagery. The quality of object imagery depends to some degree on the quality of an image obtaining apparatus used in a digital camera or video camera.

FIG. 3 shows a conventional image obtaining apparatus. The image obtaining apparatus generally includes a lens portion 11, a securing frame 12 which secures the lens portion 11, an IR-cut filter 13, and an image pick-up unit such as charge-coupled device (CCD) or a Complementary Metal-Oxide Semiconductor (CMOS) 14. In the illustrated apparatus, the lens portion 11 contains only one lens. The CCD or CMOS 14 is connected with a controlling circuit on a printed circuit board, to transmit signals to other circuitry of, say, a digital camera. The image obtaining apparatus can obtain an image of an object, and convert the object image into electrical signals. The image obtaining apparatus only includes the IR-cut filter 13, which cuts out infrared rays that may adversely affect the quality of the object image. However, the image obtaining apparatus cannot cut out other light that may adversely affect the quality of the object image, such as ultraviolet light or certain visible light. Furthermore, the image obtaining apparatus does not provide its own set of various filters that consumers may wish to use. The IR-cut filter 13 may be fixed such that it cannot be changed over. Even when a user can change the IR-cut filter 13 to other kind of filters, the other filters must be separately provided and often carried around separately. Moreover, the operation of changing over the IR-cut filter 13 is also unduly inconvenient and troublesome.

Therefore, an image obtaining apparatus which overcomes the above-described disadvantages is desired.

### SUMMARY OF THE INVENTION

Accordingly, an object of the present invention is to provide an image obtaining apparatus with a simple structure and which enables a wide range of rich object imagery to be conveniently obtained.

To achieve the above-mentioned object, an image obtaining apparatus of the present invention comprises a securing frame with a hollow center, a lens portion secured in a top of the securing frame, a rotating means comprising a turnplate and a plurality of filters embedded in the turnplate, and an image pick-up unit. The turnplate can be rotated to locate a selected one of the filters between the lens portion and the image pick-up unit. Thus a user can conveniently change filters according to the kind of object image he/she desires. The structure of the image obtaining apparatus is simple, and the turnplate is securely positioned in the image obtaining apparatus.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of an image obtaining apparatus in accordance with a preferred embodiment of the present invention, showing light paths thereof;

FIG. 2 is a top elevation of the image obtaining apparatus of FIG. 1; and

FIG. 3 is a schematic, cross-sectional view of a conventional image showing apparatus, showing light paths thereof.

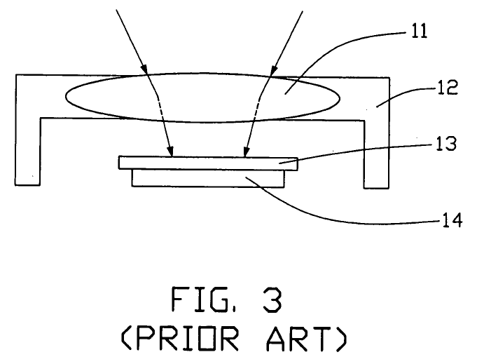

### DETAILED DESCRIPTION OF THE INVENTION

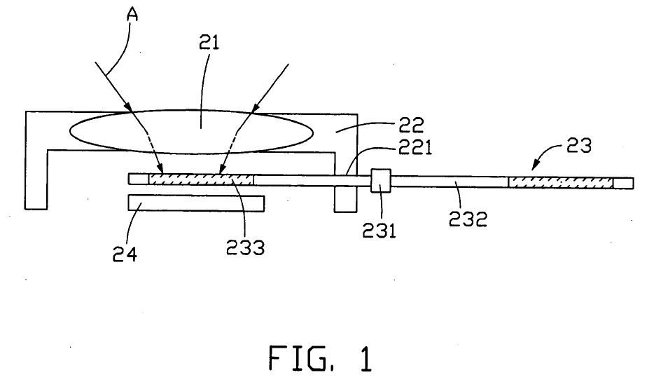

Referring to FIG. 1, an image obtaining apparatus in accordance with the preferred embodiment of the present invention comprises a lens portion 21, a securing frame 22, a rotating means 23 and a Complementary Metal-Oxide Semiconductor (CMOS) photoreceptor sensor 24.

The lens portion 21 comprises one or more lenses secured to the securing frame 22. In the preferred embodiment, only one lens is used. The securing frame 22 is a generally a low-profile cylinder, with a hollow center and an integral cap. The cap retains the lens portion 21 therein. An arcuate slot 221 is defined in a circumferential wall of the securing frame 22. The CMOS photoreceptor sensor 24 is provided in the hollow center of the securing frame 22, at a bottom thereof. The CMOS photoreceptor sensor 24 converts an object's image formed thereon through the lens portion 21 into electrical signals, which are generally then converted into digital signals. The CMOS photoreceptor sensor 24 transmits the electrical signals by way of controlling circuitry provided on a printed circuit board (not shown).

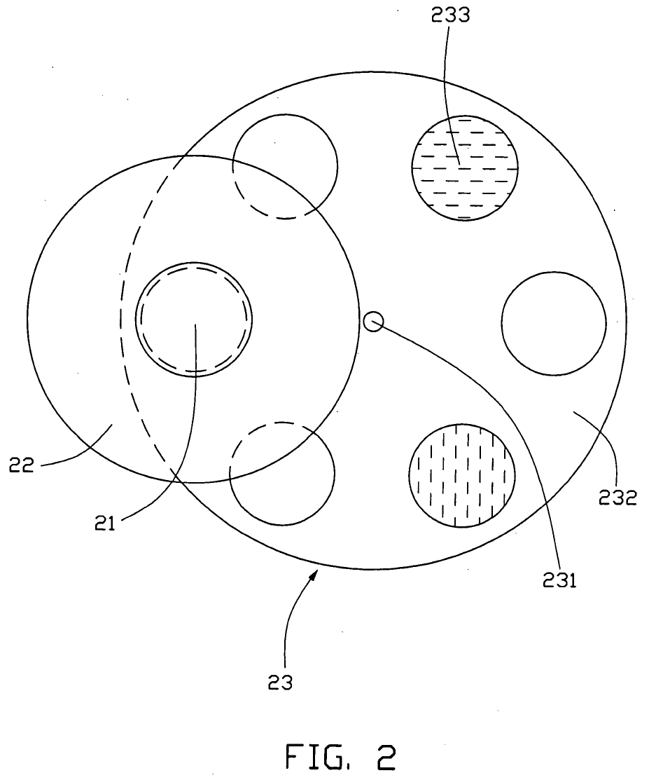

Referring also to FIG. 2, the rotating means 23 includes a stator 231 and a turnplate 232. The turnplate 232 is a circular disk, and the stator 231 is preferably fixed in a center of the turnplate 232. A plurality of filters 233 is embedded in an outer peripheral portion of the turnplate 232, in a generally circular formation equidistant from the stator 231 and equidistant from each other. The stator 231 protrudes out beyond top and bottom faces of the turnplate 232. A large portion of the turnplate 232 is disposed in the hollow center of the securing frame 22 above the CMOS sensor 24, with a corresponding part of the turnplate 232 received in the arcuate slot 221. The filters 233 can be any one or more of but are not limited to: an IR-cut filter, a low-pass filter, a visible light cut filter, an ultraviolet light filter, and an IR-absorbing filter.

Preferably, the stator 231 is fixed in the turnplate 232 and rotates together with the turnplate 232. One end of the stator 231 can be rotatably supported in a socket (not shown) of, say, a digital camera (not shown). An opposite end of the stator 231 can extend to an outside of a housing of the digital camera via a shaft (not shown). With such configuration, a button (not shown) is attached to the shaft at the outside of the housing. When the button is rotated, the stator 231 and the turnplate 232 are thereby rotated accordingly.

In an alternative embodiment, the stator 231 is fixed in, say, a digital camera, and the turnplate 232 rotates about the stator 231. A diameter of the turnplate 232 is large enough so that a segment portion of the turnplate 232 protrudes out to an outside of a housing of the digital camera. A circumferential surface of the turnplate 232 can be coarsened such as by way of having grooves defined therein, to facilitate manual gripping. A user can move the segment portion manually or with a tool, and thereby rotate the turnplate 232 around the stator 231. Alternatively, if the diameter of the turnplate 232 is not large enough for a segment portion of the turnplate 232 to protrude out to the outside of the housing, the turnplate 232 can be rotated around the stator 231 by a gear-driven mechanism.

Referring to FIG. 1, in use, the image obtaining apparatus is attached in the housing of, say, a digital camera. Incident light A passes through the lens portion 21 and a selected one of the filters 233 of the turnplate 232, and reaches the CMOS photoreceptor sensor 24. The CMOS photoreceptor sensor 24 transforms the received light into electrical signals, which are then transmitted into circuitry (not shown) of the digital camera and transformed into digital signals. A different one of the filters 233 can be used simply by rotating the turnplate 232 of the rotating means 23.

In further alternative embodiments, the stator 231 can be omitted. Instead, a center portion of the rotating means 23 is rotatably fixed in the arcuate slot 221 of the circumferential wall of the securing frame 22. Further, an IR-cut filter can be provided in the hollow center of the securing frame 22 between the lens portion 21 and the rotating means 23.

In still further alternative embodiments, the CMOS photoreceptor sensor 24 can be replaced by another kind of photo-electrical conversion means or image pick-up unit such as a charge-coupled device (CCD). Further, the generally cylindrical securing frame 22 can instead be a generally parallelepiped-shaped frame with a hollow center. Also, the circular turnplate 232 can instead be a polygonal turnplate.

From the above description, and it can be seen that the image obtaining apparatus can be used in any suitable kind of electronic device. That is, the image obtaining apparatus can be applied not only in a digital camera, but also in other imaging systems such as video cameras, home electronics imaging systems, communication industry imaging systems and military imaging systems.

It is believed that the present invention and its advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. An image obtaining apparatus, comprising:
a lens portion;
a securing frame having a hollow center, said lens portion being secured to the securing frame;
a rotating means comprising a turnplate and a plurality of filters attached to the turnplate; and
an image pick-up unit aligned with said lens portion;
wherein said turnplate can be rotated so that any selected one of the filters is disposed between said lens portion and said image pick-up unit.

2. The image obtaining apparatus as claimed in claim 1, wherein a slot is defined in a circumferential wall of said securing frame, said rotating means further comprises a stator fixed in a center of said turnplate, and a portion of said turnplate is disposed in the hollow center of said securing frame.

3. The image obtaining apparatus as claimed in claim 2, wherein said lens portion includes at least one lens.

4. The image obtaining apparatus as claimed in claim 2, wherein said securing frame is generally cylindrical.

5. The image obtaining apparatus as claimed in claim 2, wherein said securing frame is generally parallelepiped-shaped frame.

6. The image obtaining apparatus as claimed in claim 2, wherein said filters are equidistant from the center of said turnplate.

7. The image obtaining apparatus as claimed in claim 2, wherein said turnplate is a circular disk.

8. The image obtaining apparatus as claimed in claim 2, wherein said turnplate is a polygonal disk.

9. The image obtaining apparatus as claimed in claim 2, wherein said turnplate and said stator rotate together.

10. The image obtaining apparatus as claimed in claim 2, wherein said stator is fixed, and said turnplate rotates about said stator.

11. The image obtaining apparatus as claimed in claim 1, wherein said image pick-up unit is a charge-coupled device.

12. The image obtaining apparatus as claimed in claim 1, wherein said image pick-up unit is a Complementary Metal-Oxide Semiconductor photoreceptor sensor

13. An image obtaining apparatus, comprising:
a lens portion;
a moveable means having a plurality of filters thereon; and
an image pick-up unit aligned with said lens portion;
wherein a selected one of the filters is disposed between and aligned with said lens portion and said image pick-up unit.
